(19) United States
(12) Patent Application Publication
(10) Pub. No.: US 2015/0197138 A1
(43) Pub. Date: Jul. 16, 2015

(54) Automobile Sun Visor Attachment

(71) Applicant: Rainer Kuenzel, Hunt, TX (US)

(72) Inventor: Rainer Kuenzel, Hunt, TX (US)

(21) Appl. No.: 14/595,323

(22) Filed: Jan. 13, 2015

Related U.S. Application Data
(60) Provisional application No. 61/964,854, filed on Jan. 16, 2014.

(51) Int. Cl. B60J 3/02

(52) U.S. Cl. CPC B60J 3/0208

(57) ABSTRACT

An automobile sun visor attachment is configured to attach to a sun visor. The attachment includes means to easily apply and remove the attachment to an existing sun visor. An opaque or dark translucent blade is flexibly joined to the existing visor offering degrees of freedom of movement, allowing the user to orient the blade at any desired position and orientation.

This application claims the benefit of U.S. Provisional Patent Application Ser. No. 61/964,854 filed Jan. 16, 2014.

### FIELD OF THE INVENTION

This application relates generally to the field of automobile sun visors and, more particularly, to an attachment arranged to be removably coupled to the visor of an automobile and repositioned to suit the user without having to adjust the positioning of the existing visor to which it is attached.

### BACKGROUND OF THE INVENTION

Since the earliest automobiles took to the roads, they have been equipped with sun visors to help shield the driver's and passengers' eyes from glare from sunlight. A typical sun visor comprises an opaque material that can be rotated to position the visor at the choice of the user, and rotated out of the way when not in use. The most familiar type of automobile sun visor moves with two degrees of freedom, with a vertically oriented post to allow movement of the visor left and right and a horizontal axis the permit rotation of the sun visor up and down.

Many improvements have been made to this typical sun visor, commonly in the form of attachment to the visor. Vandagriff, U.S. Pat. No. 5,445,427; is exemplary of the art. The '427 patent teaches a sun visor attachment that secures to a pre-existing sun visor. A main body of the attachment having laterally and vertically extendable panels is secured to the pre-existing sun visor. A wing body is connected by a multi-axis pivot to the main body portion and is swung away from a closed position adjacent the main body to an open position, including discrete rotations from the vertical. The wing body also has vertically and laterally extendable panels and, in addition, has a support assembly for maintaining the wing body in its open position.

However, to use the visor attachment of the '427 patent, the driver must move the existing sun visor to position the visor and attachment to a desired position. Thus, there remains a need for a sun visor attachment that permits the driver to leave the existing visor in a default position while independently moving an attachment on the visor to a desired orientation. The attachment disclosed herein solves these and other needs in the art.

### SUMMARY OF THE INVENTION

The automobile sun visor attachment disclosed herein solves many of these types of problems a driver faces when driving in a variety of light glare conditions. For example, a driver might encounter different driving conditions while driving into the sun when it is in a low position, or when driving at night, especially on a rainy day, facing blinding lights from oncoming traffic. Alternatively, a driver might be blinded by a backwards facing outside minor with a following driver using headlamps set on high beams. Conditions also change as a driver moves along a curving road as the source of the glare moves along the driver's field of view.

By using the attachment of this disclosure, a driver can leave the existing visor of the automobile in its place to cover a bright sky or blinding white clouds in front of the windshield, while using the herein disclosed attachment visor for coverage on the side. It solves the problem of having to move the visor from front to side, as the automobile keeps changing direction and the sun moves back and forth between front and side.

As the attached visor is moved to the side, it can also be rotated up or down, depending on the height of the sun from the side. It can be moved down enough to cover the outside minor, which cannot be dimmed like the inside rear view mirror, since a drive can be blinded by a careless driver approaching from the rear without dimming their lights from high to low beam.

The attachment visor can also be put into a vertical position on the left side of the windshield to eliminate glare at night from oncoming traffic, which would be especially useful on a rainy night, when every raindrop on the windshield outside of the reach of the wiper blade acts like a tiny bright lantern.

Drivers who are short enough to just barely look over the steering wheel would appreciate the possibility to use the attachment visor as a downward extension to the existing visor.

These and other features and advantages will be apparent to those of skill in the art from a study of the following disclosure along with the accompanying drawings. For example, the attachment may be produced and sold as retrofit equipment, or as original equipment on an automobile.

### BRIEF DESCRIPTION OF THE DRAWINGS

FIG. 1 is a rear view of the visor attachment as seen by a driver, mounted on an existing automobile visor.

FIG. 1A is another presently preferred embodiment of a visor attachment that may be installed by an automobile manufacturer as original equipment, rather than as a retrofit.

FIG. 2 is a side view of the visor attachment of FIG. 1.

FIG. 3 is a bottom view of the visor attachment of FIG. 1.

FIG. 4 is a cross section view as seen along section lines 4-4 in FIG. 1.

FIG. 5 is a cross section view as seen along section lines 5-5 in FIG. 1.

FIG. 6 is a cross section view as seen along section lines 6-6 in FIG. 1.

FIG. 7 is a detail view of a preferred embodiment of a main knee of FIG. 1.

FIG. 8 is a side detail view of the main knee shown in FIG. 7.

FIG. 9 is a view, as seen by a driver looking forward through a windshield, showing the attachment visor mounted onto the main visor in a storage position.

FIG. 10 is a view, as seen by a driver looking forward through a windshield, showing the existing visor together with the attachment visor tilted down.

FIG. 11 is a view, as seen by a driver looking forward through a windshield, of a visor tilted down with attachment visor rotated out to the side.

FIG. 12 is a view, as seen by a driver looking forward through a windshield, of a visor tilted down with attachment visor rotated out to the side and partially rotated down along a horizontal axis.

FIG. 13 is a view, as seen by a driver looking forward through a windshield, of a visor down and partially forward with the attachment visor partially down, serving as downward extension of the existing.

FIG. 14 is a view, as seen by a driver looking forward through a windshield, of a visor in its storage position with the attachment visor in a vertically downward position to shield against blinding lights from oncoming traffic at night off to the left of the driver.

FIG. 15 is a view, as seen by a driver looking forward through a windshield, of a visor in its storage position with the attachment visor down to provide shielding from the outside driver's-side rear view mirror.

FIG. 16 is a view, as seen by a driver looking forward through a windshield, of a visor in a down position, rotated to the side, with the attachment visor down to serve as downward extension of the existing visor.

FIG. 17 is a view, as seen by a driver looking forward through a windshield, of a visor in a down position, rotated partially backwards, with the attachment visor down and rotated to the side.

FIG. 18 is a view, as seen by a driver looking forward through a windshield, of a visor in a down position, rotated partially forward, with the attachment visor down from the existing visor and rotated to the side’

FIG. 19 is a view, as seen by a driver looking forward through a windshield, of a visor in a down position, with the attachment visor rotated to the side and down to cover outside minor.

FIG. 20 is a view, as seen by a driver looking forward through a windshield, of a presently preferred embodiment of the visor attachment with a sliding extension.

### DETAILED DESCRIPTION OF PREFERRED EMBODIMENTS

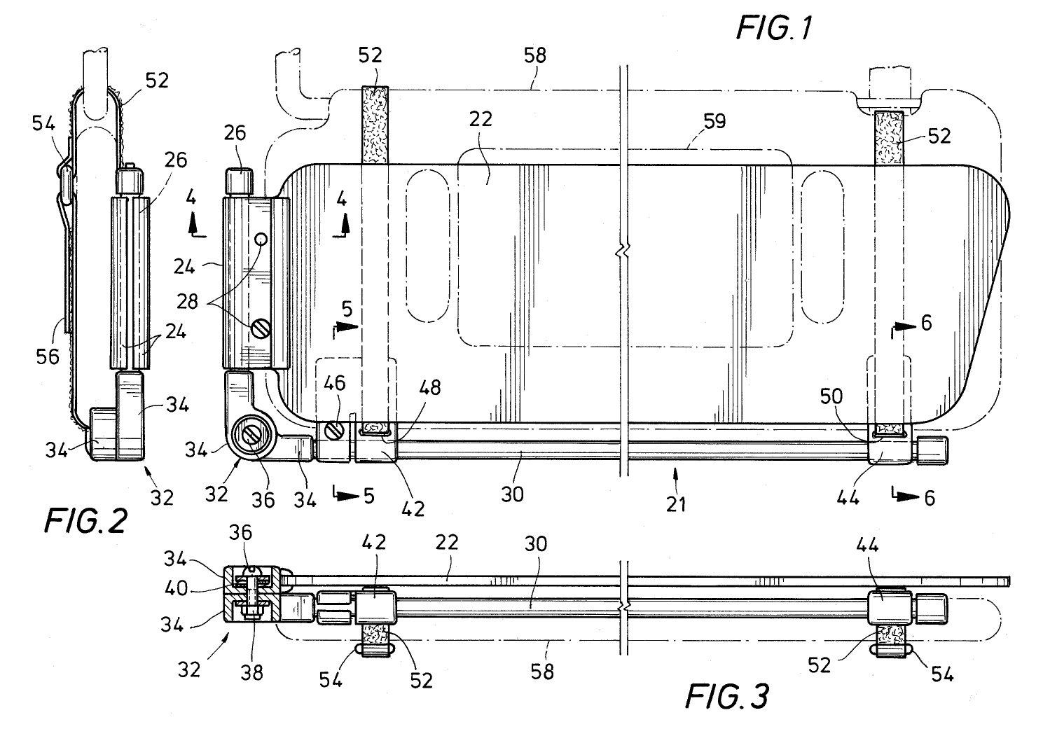

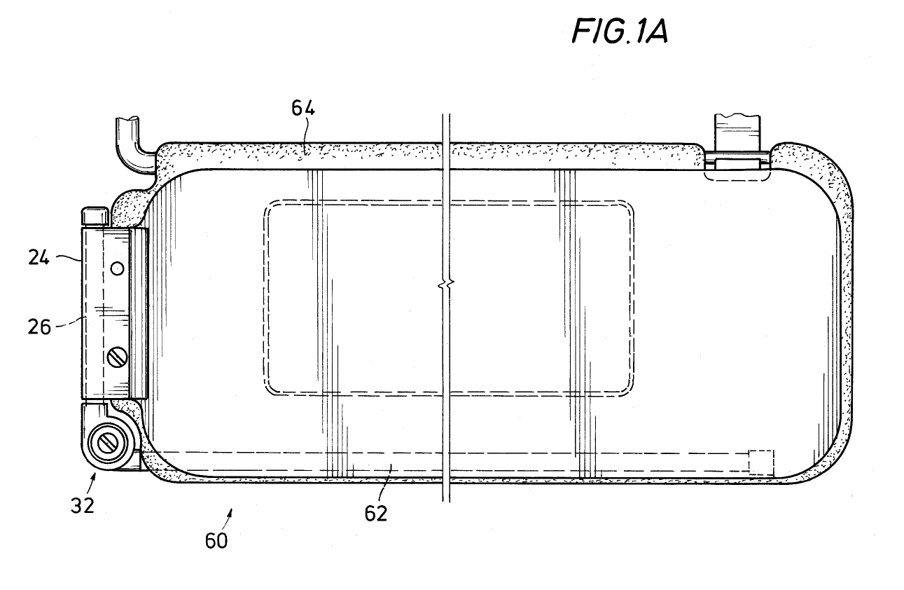

FIGS. 1, 2, and 3 illustrate a presently preferred embodiment of a visor attachment assembly 21 in its intended environment, i.e. attached to an existing sun visor 58. The visor attachment assembly 21 includes a foam board blade 22 which is joined to two clamp halves 24. The foam board blade is preferably opaque, but may be made of a dark, polarizing material that stops glare but allows some view through the blade 22. Whatever the material that is chosen, it must be lightweight to minimize the frictional forces necessary to maintain the positions of the blade that are chosen by the user, and yet it must be strong enough to provide robust support. The clamp halves 24 are cantilevered on and rotatably positioned around a vertical shaft 26. The friction between the clamp halves 24 and the shaft 26 can be increased by tightening one or both of a pair of screws 28. A horizontal rod 30 connects to the shaft via a hinge knee 32. The hinge knee 32 comprises two halves 34 jointed together about an axis, which are connected by a co-axial screw 36 and a lock nut 38 (FIG. 3). Wavy (compressible) washers 40 are placed under the head of the screw 36. The friction between the knee halves 34 can be increased by tightening the screw 36, thereby compressing the wavy washers 40.

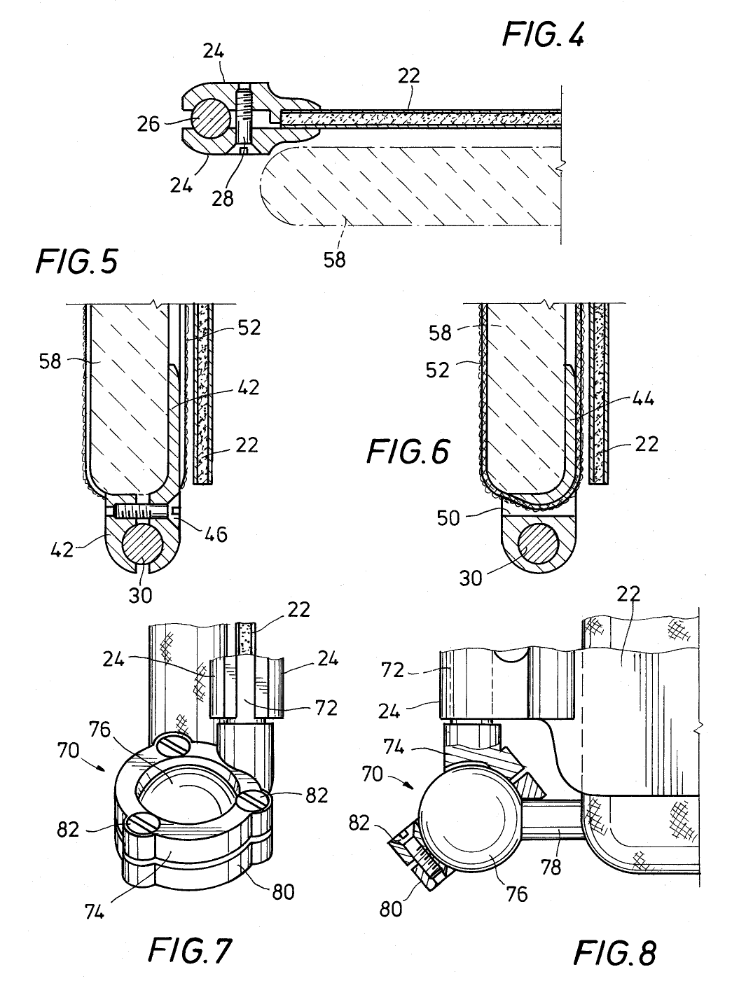

FIGS. 1, 2, and 3 also illustrate one preferred way to attach the visor attachment to an existing visor, although many such attachment methods may be used within the spirit and scope of this invention. In the figures, two saddle pieces 42 and 44 ride on the horizontal rod 30. Further details of the saddle pieces are shown in FIGS. 4, 5, and 6 and described below. The rotational friction between the rod 30 and the saddle piece 42 can also be increased by tightening a screw 46. The saddle pieces 42 and 44 are equipped with slots 48 and 50, respectively, through which Velcro® belts 52 are fed. Each belt 52 is equipped with a belt buckle 54 to receive a belt end 56. Each belt 52 can be placed around the existing visor 58 and tightened by pulling on its respective belt end 56 and pressing them against belt 52. Preferably, the belts 52 are spaced apart so as not to obscure a vanity mirror 59 on the existing visor 58. In another preferred alternative embodiment, the saddle piece 44 is replaced by a second saddle piece 42 to increase the rotational friction even more between the saddle pieces and the rod 30.

FIG. 1A shows another presently preferred embodiment of a sun visor attachment 60 as made by the automobile manufacturer, and not as a retrofit item of equipment. In FIG. 1A, a rod 62 is placed inside the automobile's existing visor 64, eliminating the saddle pieces 42 and 44, which are only required for the after-market (retrofit) variation.

FIGS. 4, 5, and 6 illustrate cross sections of FIG. 1 to illustrate in more detail how the saddle pieces 42 and 44 are held in place on the rod 30 under the bottom edge of the existing visor 58. As shown in FIG. 4, a section view along section lines 4-4 of FIG. 1, the foam board blade 22 is joined to two clamp halves 24 and held in place around the vertical rod 26, preferably by an adjustable screw 28. FIG. 5, a section view along section lines 5-5 of FIG. 1, shows the mounting of the saddle piece 42 around the rod 30 and held in place by an adjustable screw 46. In contrast, FIG. 6, a section view along section lines 6-6, shows a saddle piece 44 which entirely encircles the rod 30. FIG. 6 also illustrates the slot 50, through which the belt 52 is threaded and them tightened to attach the attachment to the existing visor 58.

FIGS. 7 and 8 show a presently preferred embodiment of a joint that may be used in place of the hinge knee 32. The embodiment of FIGS. 7 and 8 includes a universal ball joint 70. A rod 72 is connected to a ball receiving end 74, inside which a ball-shaped end 76 of a rod 78 is held by a retainer ring 80. Those of skill in the art will recognize that the rod 78 corresponds in the embodiment of FIG. 8 to the rod 30 of FIG. 1. A pair of screws 82 attach the retainer ring 80 to the ball receiving end 74. The friction between ball receiving end 74 and the ball-shaped end 76 can be increased by tightening the screws 82, preferably uniformly.

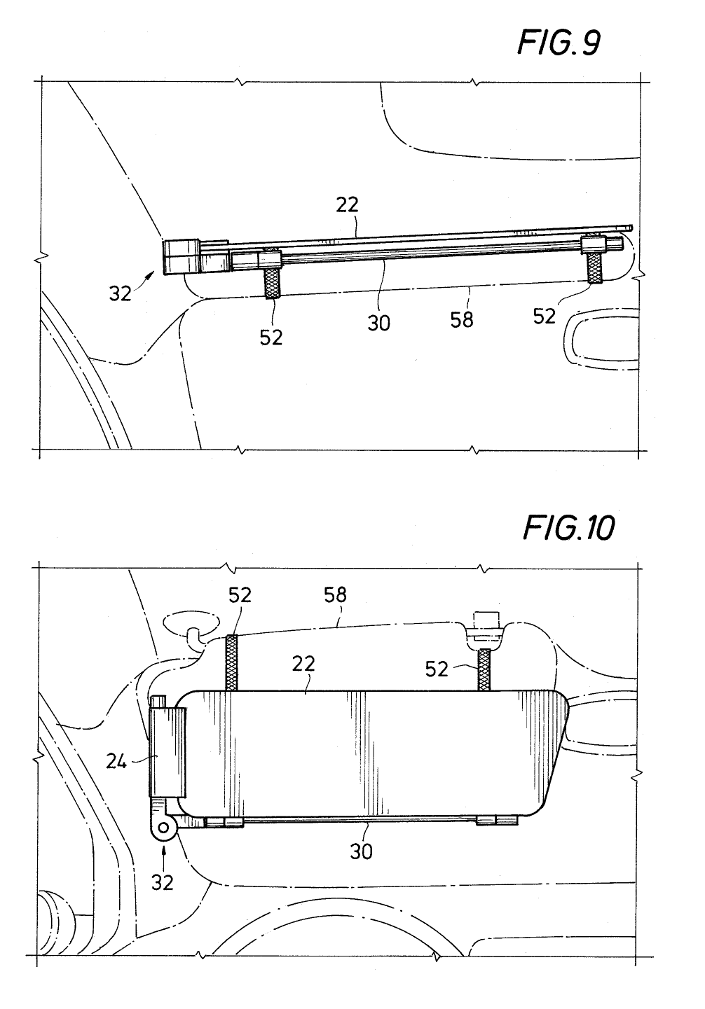

FIGS. 9 to 20 illustrate the most useful positions of the foam board blade 22 relative to the existing visor and the automobile. For example, FIG. 9 shows the visor attachment mounted onto the main visor in a storage position. This is the position of the existing visor and its attachment where it will be positioned most of the time, i.e. without glare annoying the driver. FIG. 10, with the visor and the attachment lowered down, the assembly operates in a manner similar to the existing visor without the attachment.

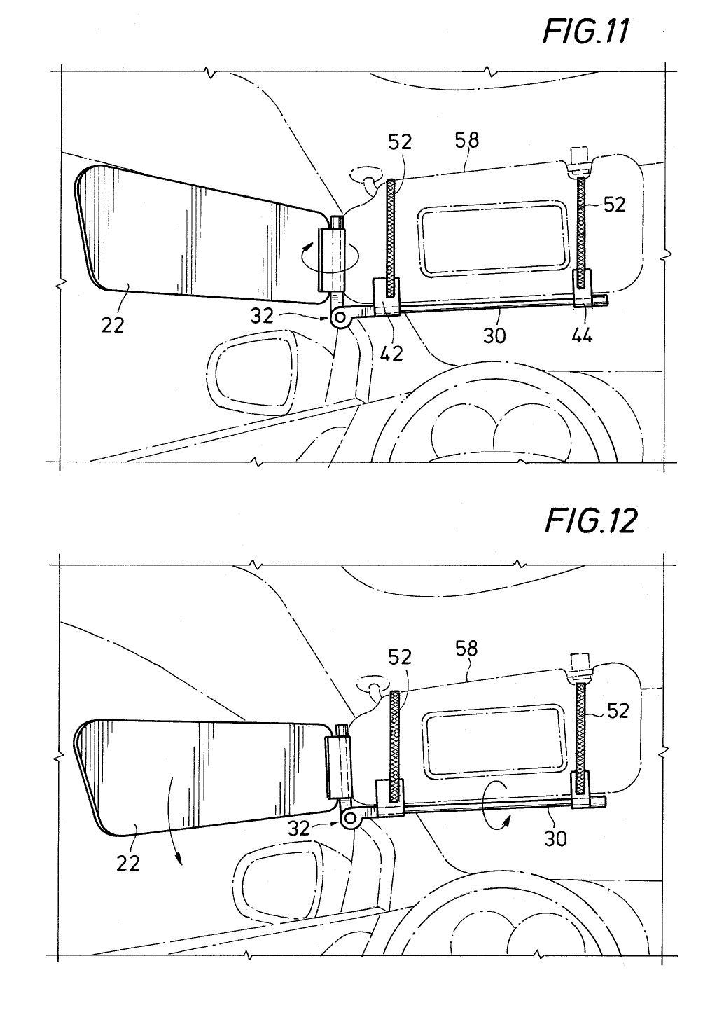

In FIG. 11, the visor attachment is rotated to the left as seen in the drawing, to block glare from the left of the driver. FIG. 12 illustrates the foam board blade lowered down, rotated slightly about the rod 30, to block glare lower down through the driver's side window.

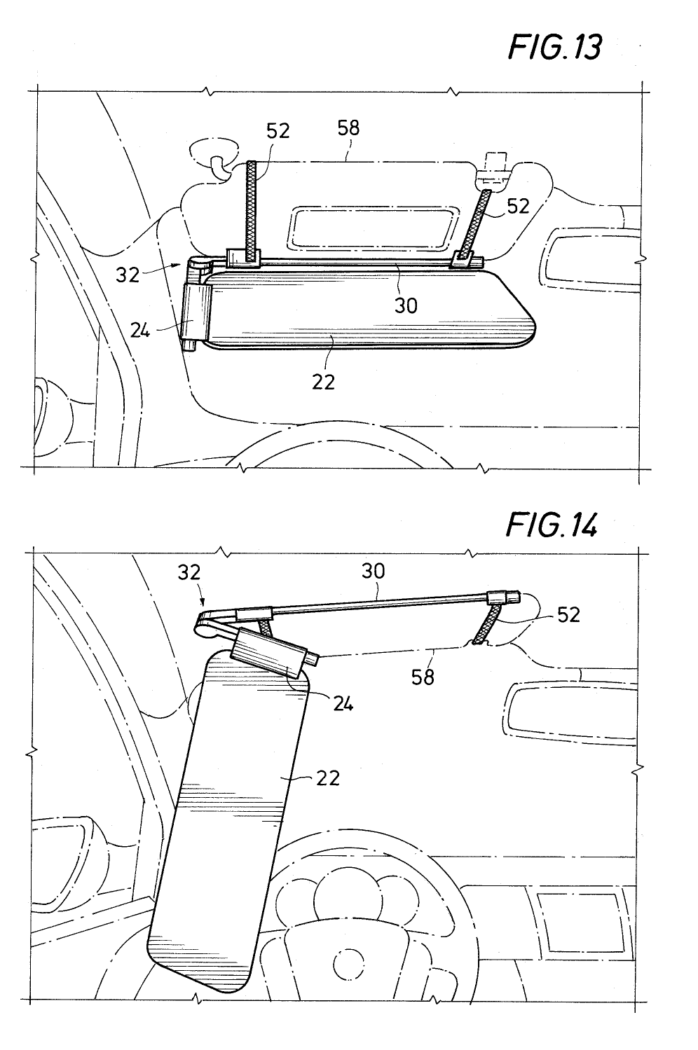

In FIG. 13, the existing visor 58 is rotated down from its storage position and the blade 22 is also rotated down to a position immediately below the existing visor. FIG. 14 shows the existing visor 58 in its up or storage position and the blade positioned in a rotated and downwardly extended position. This position of the blade is useful to block glare from approaching headlamps, whether because they are on high beam or because the light from the headlamps is reflected off the roadway, such as during a rain.

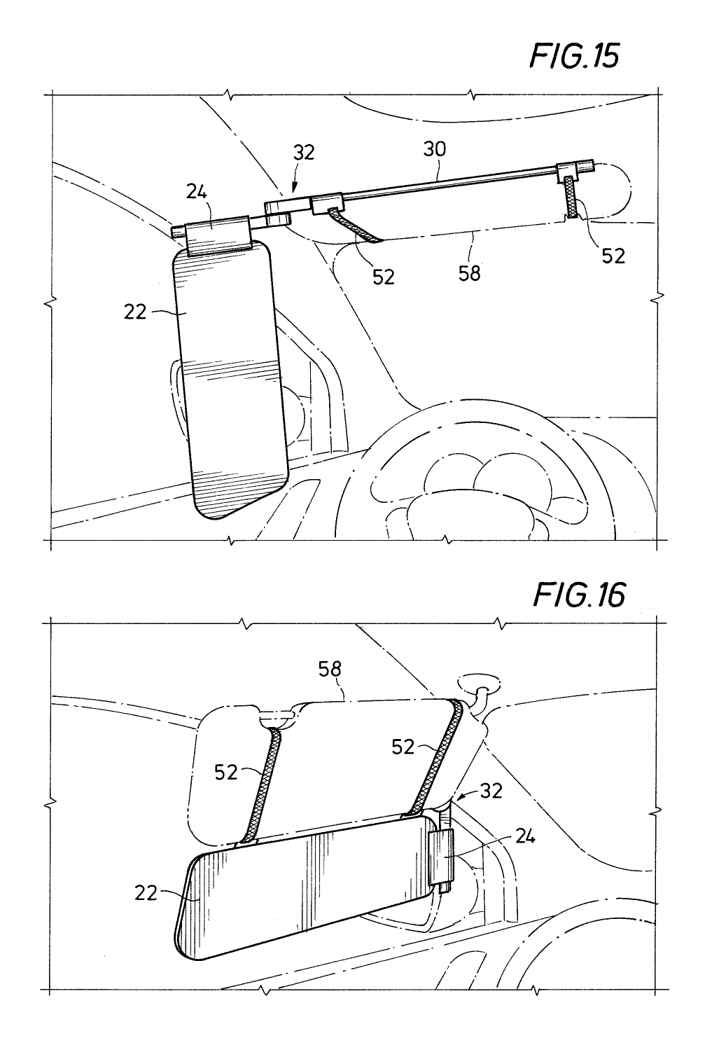

FIG. 15 shows the blade 22 positioned to block glare from the driver's side rear view minor by rotating the blade about the hinge knee 32. In FIG. 16, the existing visor 58 is rotated to the left and the blade 22 is simply lowered by rotating about the rod 30. This orientation of the assembly effectively blocks glare from all of the driver's side window.

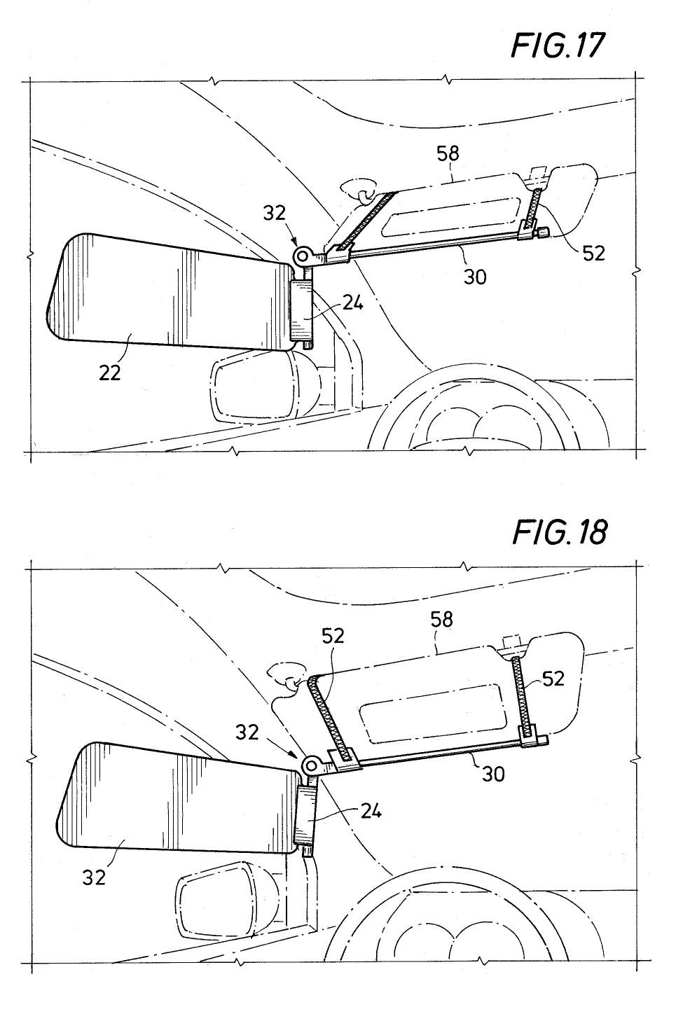

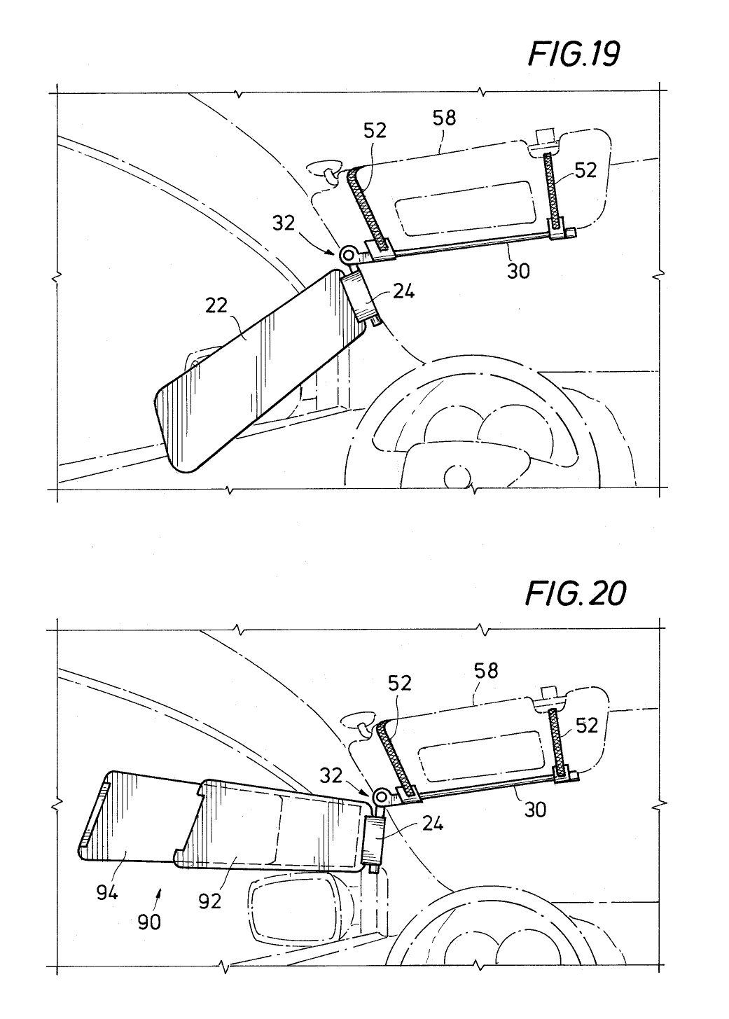

FIG. 17 illustrates the combination of the existing visor and the visor attachment with the existing visor angled back toward the driver at roughly a 45° angle, with the visor attachment positioned to the left of the driver, approximately parallel to the driver's side window. Similarly, in FIG. 18, the existing visor is angled away from the driver and approximately 45° with the visor attachment as before in FIG. 17. Recall that the joint 70, shown in FIGS. 7 and 8, could be used in place of the hinge knee joint 32 for even greater flexibility. FIG. 19 shows the existing visor in the same position as in FIG. 18, but the visor attachment is rotated down using the hinge knee 32 to block glare from the driver's side minor.

Finally, FIG. 20 illustrates an additional feature 90 wherein the blade comprises a hollow sleeve-like blade portion 92 and a second extension blade 94. The extension blade 94 is inserted into the hollow space of the blade portion 92 and can slide in and out to change the combined length of blade 90. As before, the blade portion 92 and the extension blade 94 may be made of a opaque material, or a dark polarizing material, or any appropriate material.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. An automobile sun visor attachment configured to attach to a sun visor, the attachment comprising:
a. means to couple the attachment to the sun visor;
b. a blade;
c. a horizontal rod joining the blade to the means to couple the attachment to the sun visor; and
d. a vertical rod joined to the blade; and
e. a joint joining the vertical rod to the horizontal rod.

2. The attachment of claim 1, wherein the means to couple comprises at least one strap.

3. The attachment of claim 2, further comprising a saddle piece arranged to rotatably ride on the horizontal rod, the saddle piece defining a slot through which the at least one strap is inserted.

4. The attachment of claim 1, wherein the joint comprises a hinge joint.

5. The attachment of claim 4, wherein the hinge joint comprises two halves jointed at an axis and further comprising a co-axial screw joining the two halves and arranged to adjust frictional between the two halves.

6. The attachment of claim 1, wherein the joint comprises a ball joint.

7. The attachment of claim 1, wherein the blade comprises:
a. a hollow, sleeve-like blade portion; and
b. an extension blade 94 arranged to slide in and out of the sleeve-like blade portion.

8. A sun visor assembly comprising:
a. a sun visor;
b. a sun visor attachment;
c. means to couple the sun visor attachment to the sun visor;
d. wherein the sun visor attachment comprises:
i. a blade;
ii. a horizontal rod joining the blade to the means to couple the attachment to the sun visor; and
iii. a vertical rod joined to the blade; and
iv. a joint joining the vertical rod to the horizontal rod.

9. The assembly of claim 8, wherein the means to couple the sun visor attachment to the sun visor comprises a pair of spaced apart straps.

10. The assembly of claim 9, wherein the pair of spaced apart straps are made at least in part of Velcro®.
